(19) United States
(12) Patent Application Publication
(10) Pub. No.: US 2003/0196524 A1
(43) Pub. Date: Oct. 23, 2003

(54) Wrench device

(76) Inventor: Shayne D. Williams, Missoula, MT (US)

Correspondence Address: DOWREY RICKARDS, 19119 NORTHCREEK PARKWAY, SUITE 106, BOTHELL, WA, 98011, US

(21) Appl. No.: 10/128,972

(22) Filed: Apr. 22, 2002

(51) Int. Cl. B25B 13/00

(52) U.S. Cl. 81/124.4

(57) ABSTRACT

A hand held wrench device having an elongated handle with an enlarged end area on one or both ends to accommodate varying size wrench openings. The wrench openings are arranged in a tight cluster with sufficient spacing therebetween to provide adequate strength to withstand design torqueing stresses. In one embodiment the wrench openings are arranged in one or more circumferential patters about a centrally located wrench opening.

### BACKGROUND OF INVENTION

### BACKGROUND OF THE INVENTION

1. Field of the Invention

The present invention relates to hand held wrench devices in general and more particularly to a hand held wrench having an elongated handle and including a plurality of different size wrench openings located at one or both ends of the wrench handle. The wrench device is configured so as to retain normal wrench “feel” regardless of t he wrench opening being used and for applying substantial torque capabilities in various environments and restricted working areas.

2. Description of the Prior Art

Situations commonly arise in the mechanical repair arts requiring a number of different size wrench openings such as box wrench openings to complete a mechanical repair. The usual solution is the maintaining of a complete tool box full of wrenches and wrench sets in order to be prepared for any common wrench standard or size requirement. In recent years not only is a multitude of sizes required but different manufacturers have originated different wrench configuration standards, not in the least limited to polygonal shapes. To add to this dilemma, and especially in the automotive repair fields, there are not only domestic standards, i.e. American standard sizes, but foreign auto imports have introduced the widespread use of metric standard sizes. A typical auto lube bay operation, as an example, must be able to handle both domestic and foreign vehicles with each model of domestic and foreign automobile most likely having different sized oil drain plugs. These rather common and straight forward lube bay requirements alone may dictate having a full set of both metric and American standard box end wrench sizes. These wrench sets must, of course, be stored in the lubrication pit for removing oil plugs in a rather restricted under-car area. There are other specialized areas of mechanical work where the same problem exists, and especially in the auto repair service industry. Although some attempts have been made in the prior art to provide hand wrenches which include a plurality of wrench openings sizes, these prior art wrenches for the most part are inadequate for situations wherein wrench application must be made in a restricted area and/or substantial torque is required to perform a particular procedure. Also, the prior art wrenches of this type have not generally provided a sufficient number wrench openings for the various standard sizes, especially of the box end wrench type. The following listed patents are illustrative of prior art multiple opening hand wrenches:

U.S. Patent Patentee

U.S. Pat. No. 5,425,292 Mobile

Des. No. 120,489 Musselman

Des. No. 360,117 Mobile

Des. No. 402,515 McIntyre

The common shortcomings of the wrench devices in the patents cited include generally inadequate numbers of wrench openings, the limited torqueing capabilities of the wrench because of size and configuration as well as location of the wrench openings relative to the wrench handle.

### SUMMARY OF INVENTION

The present invention contemplates a hand held wrench device with increased versatility and expanded utility over known prior art multiple opening wrenches. The elimination of the need for purchasing and maintaining a multitude of wrenches and wrench sets not only results in cost savings but will provide storage space savings in those situations where the work and storage must be accomplished in limited spaces. The present wrench device is specially suited for work requirements which involve not only a multitude of wrench sizes but also several wrench size standards. The wrench device may include an elongated handle for applying substantial torque in restricted spaces such as oil pan plug removal where large size plugs have been subjected to harsh environmental conditions and are thus difficult to remove. The configuration of the wrench includes a tight clustering of box end wrench openings about the center point of each end of the wrench such that the device retains the “feel” of the regular box end type wrench. When adapted for lube bay work, the wrench may be made completely flat so as to be rotatable 180° and still be applied to a drain plug in restricted under-car environments. For other specific uses, the wrench may also include a standard double or single offset in the handle in a manner commonly known in the art. When providing a cluster of box end wrench openings on each end of the wrench handle, it may be seen that a wide range of metric and American standard size wrench openings, e.g. from 10 mm through 24 mm metric on one end and ½″ to 1″ on the other end, is possible as shown in the illustrated example.

### BRIEF DESCRIPTION OF DRAWINGS

FIG. 1 is a perspective view of the wrench;

FIG. 2 is a plan view of the wrench;

FIG. 3 is a left side edge elevational view of the wrench of FIG. 2;

FIG. 4 is a right side edge elevational view of the wrench of FIG. 2;

FIG. 5 is a top end elevational view of the wrench of FIG. 2;

FIG. 6 is a bottom end elevational view of the wrench of FIG. 2; and

FIG. 7 is an enlarged detailed broken plan view of the top and bottom end areas of the wrench of FIG. 2.

### DETAILED DESCRIPTION

Referring to the drawings, a wrench device according to the present invention is indicated generally at 10. The wrench 10 of the illustrated embodiment may comprise a single piece body indicated generally at 11 constructed of steel or suitable alloy having sufficient hardness, heat treated or otherwise, to withstand the stresses to which the wrench is to be subjected according to its design criteria. The wrench body may be fabricated by such means as cold forging, stamping, laser cutting from flat stock or casting. The manufacturing method may depend upon the desired thickness of the wrench body or other limitations such as the manufacturing cost and materials used in the manufacture. As illustrated in the preferred embodiment, the wrench body is preferably manufactured from ¼″ flat stock, having two parallel faces 12 and 13 respectively. The wrench body includes an extended handle 14 and enlarged wrench areas located at opposite ends thereof.

Although the illustrated embodiment is generally flat and constructed of completely flat stock, it will be understood that this configuration is preferred for lube bay work and that other configurations of the wrench may require the end clusters of wrench openings to be offset from the wrench handle as previously explained. It will also be understood that, although the handle 11 is shown with parallel faces and side edges, embellishments or contour deviations from this configuration are possible and are contemplated within the spirit of the present invention which is not limited to the surface details.

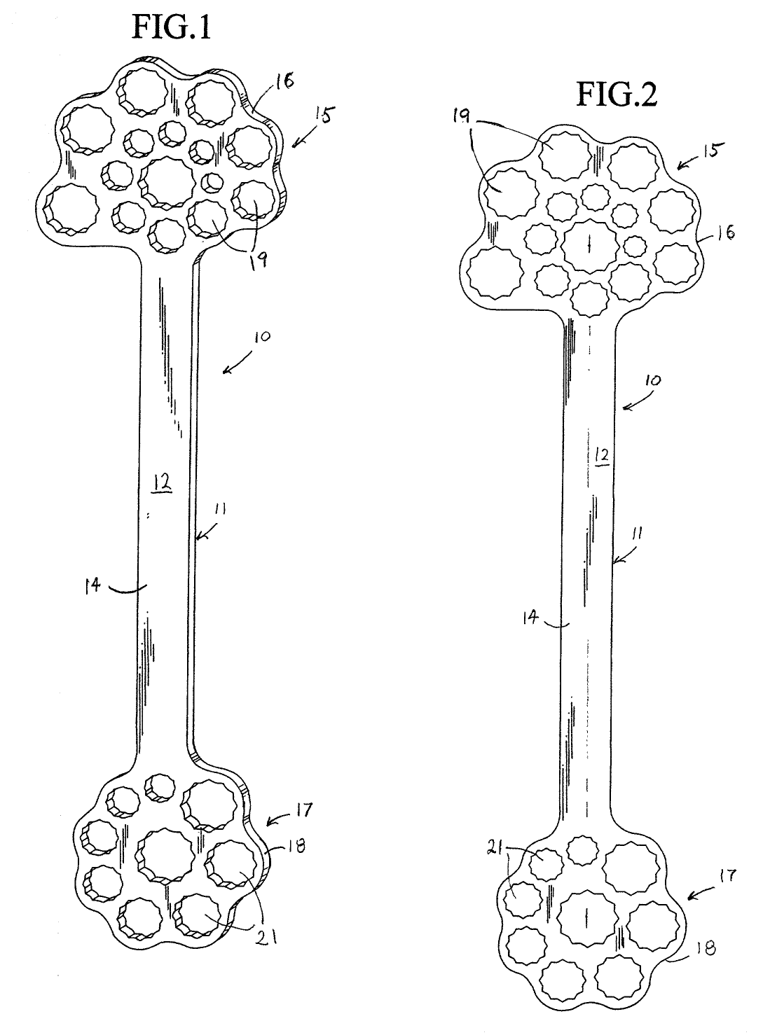

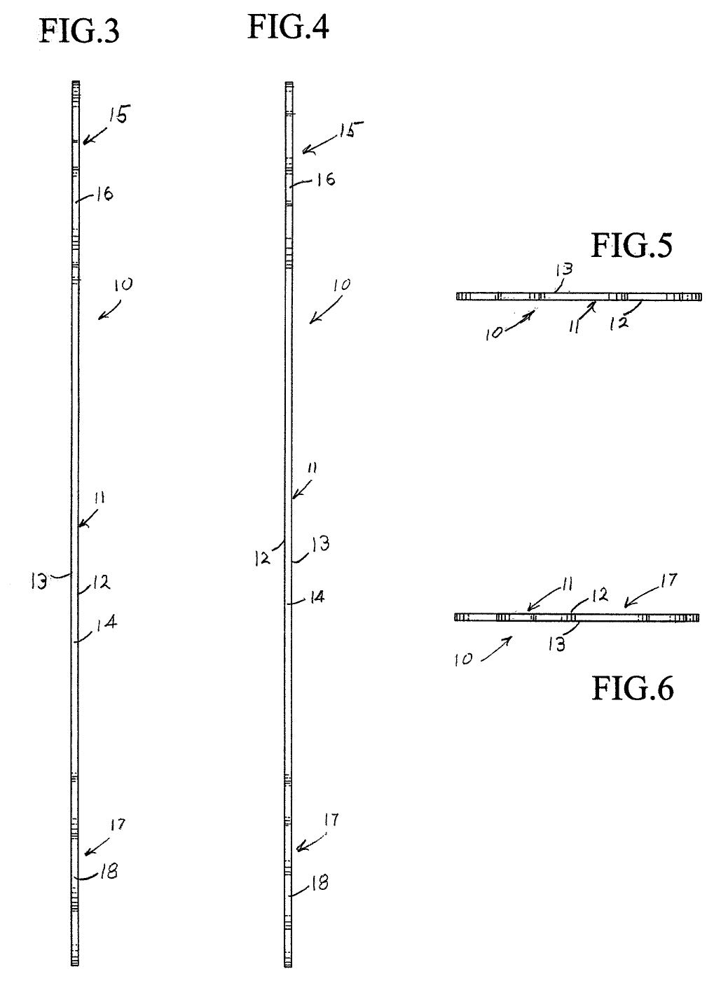

As seen in the drawings, the top end of the wrench, as viewed in FIG. 1, includes an enlarged area 15 having a generally curvilinear or lobed circumferential edge 16 for mounting a first plurality of wrench openings. The bottom end as viewed in FIGS. 1 and 2 includes a second enlarged end area 17 also having a curvilinear or lobed edge 18. The exact outline of the edges 6 and 18 may be varied as a matter of design or appearance while accommodating the preferred placement and size of the wrench openings as presently to be described in detail.

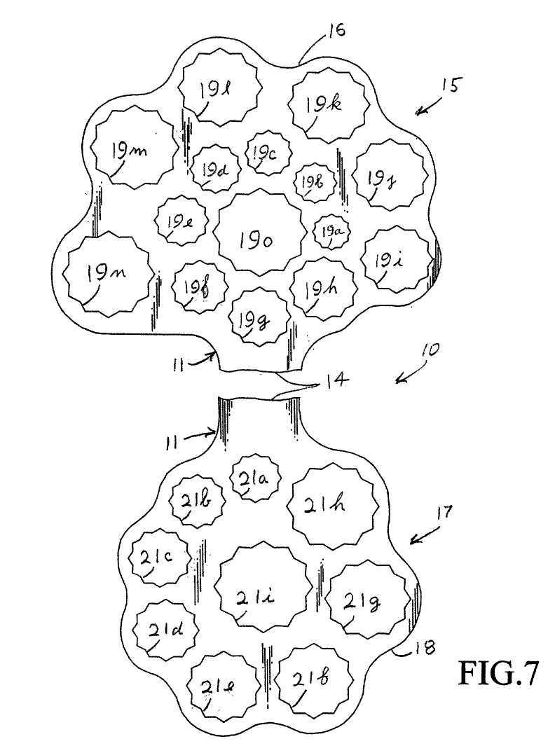

As seen in FIGS. 1 and 2 in the illustrated embodiment, the end area 15 is provided with a plurality of wrench openings 19, shown as fifteen in number, with a central opening being intersected by the longitudinal central axis of the handle 14. Referring to FIG. 7, the plurality of wrench openings are designated 19a-19o and are arranged in a close or tight cluster about the periphery of the central wrench opening 19o. Although the exact placement of the wrench openings may be varied well within the scope of the present invention, the openings are preferably located in a circumferential path or array about the central opening 19o in as tight a radius as possible. This arrangement allows the wrench to be used in a relatively restricted space while maintaining the wrench “feel” when in use. For most purposes, and especially for the primary use as a lube bay wrench, the end area 15 may be of a size so as to accommodate, as an example, a range of metric sizes of 20 mm thru 24 mm. The layout of the wrench openings will also be dictated by the provision of sufficient wrench body material between the openings so as to provide the requisite strength to withstand a predetermined torqueing application. For most purposes approximately ⅛″ of material is recommended between openings to provide sufficient strength. In the present embodiment, the openings 19a-19o are represented as 12-point box end style which allows the wrench to be oriented in many different positions so as to be operable in a restricted space such as an under-car environment.

As seen in FIGS. 1 and 2, the enlarged end 17 on the opposite end of the wrench is provided with a second plurality of wrench openings 21, in this case nine in number, with a central opening being intersected by the longitudinal central axis of the handle 14. Referring to FIG. 7, the plurality of wrench openings are designated 21a-21i and are arranged in a tight cluster about the central wrench opening 21i in the manner described for the openings in end area 15. The wrench openings 21a-21i are arranged to accommodate American standard box wrench opening sizes from ½″ thru 1″, again in the preferred 12-point box end wrench configuration for the reasons pointed out above. It will also be understood that preferably ⅛″ spacing should be provided between wrench openings for adequate strength. This may vary, however, depending on the material of construction.

The present invention provides an improved wrench device which is capable of replacing a plurality of wrench sets and which is adapted for use in restricted areas such as under-car auto lube operations. It will be understood, however, that the use of the present wrench device is not limited to any specific application but is of particular value under conditions where a wide variety of wrench sizes and standards, not necessarily American or metric, is required and wherein storage or operating room is a consideration. In practice, the length of the handle portion of the wrench may be varied but a handle length in the neighborhood of approximately 11″ is preferred so as to enable sufficient torque capabilities for loosening nuts, bolts or plugs which may be temporarily frozen in position for one reason or another. The flat configuration of the preferred embodiment which permits the wrench to be turned 180° to obtain a sufficient purchase in tight spaces is of particular application in lube bay work. While preferred embodiments of the invention have been described herein, it is to be understood that the foregoing description and accompanying drawings have been given by way of illustration and example only. Variations of design and arrangement of parts may be made without departure from the scope and spirit of the present invention. For example, the length, configuration and/or embellishment of wrench handle 14 may be altered. Likewise, the exact shape and contours of the large wrench ends may be changed. The number, arrangement and sizing of the wrench openings in the enlarged wrench ends may be altered as well as the distance between the various openings and the relative proportions between the enlarged ends and the extended wrench handle. Similarly, in its broadest scope, the invention also contemplates structural modifications such as offsetting portions of the handle from the enlarged end areas and the utilization of enlarged end areas on only one or on both ends of the handle. Changes in form and of the several parts, substitution of equivalent elements and arrangement of parts which will be readily apparent to one skilled in the art, are also contemplated as being within the scope of the present invention which is to be limited only by the claims which follow.

1. A wrench device having a wrench body comprising;
an elongated wrench handle,
at least one enlarged head located at one end of said handle,
a plurality of wrench openings formed in said at least one enlarged head,
said wrench openings being arranged in a tight cluster within the area of said enlarged head and spaced apart a distance providing sufficient wrench body therebetween to withstand predetermined stresses resulting from a designed torque level for the wrench device.

2. The wrench device of claim 1 wherein said enlarged wrench head comprises a first wrench head, said wrench openings comprise a first cluster, said wrench device further including;
a second enlarged wrench head on the other end of said elongated handle and including a second cluster of wrench openings.

3. The wrench device of claim 2 wherein;
said wrench body is formed from cold forged flat metal stock
said wrench body has an approximate thickness of ¼″,
said wrench openings are spaced apart a minimum distance of approximately ⅛″, and
said handle has a length of approximately 11″.

4. The wrench device of claim 3 wherein said wrench openings of said first and second clusters comprise varying size box end wrench openings, and
one of said first and second clusters comprises American Standard sizes, the other of said first and second clusters comprising metric standard sizes.

5. A wrench device having a wrench body comprising;
an elongated handle having a central longitudinal axis,
an enlarged wrench head formed on at least one end of said handle and including a central point located on the handle axis,
a plurality of wrench openings arranged in an array about said central point,
said array comprising a tight cluster of varying size wrench openings,
said openings being spaced apart a distance providing sufficient wrench body therebetween to withstand predetermined stresses resulting from a designed torque level for the wrench device.

6. The wrench device of claim 5 wherein said central point is defined by a central wrench opening and said array of wrench openings is arranged in a generally circumferential pattern thereabout.

7. The wrench device of claim 6 including a plurality of said arrays arranged generally circumferentially about said central wrench opening.

8. The wrench device of claim 5 wherein said enlarged wrench head comprises a first wrench head, said array comprises a first array, said wrench device further including;
a second enlarged wrench head formed on the other end of said elongated handle and including a second array of wrench openings arranged in a tight cluster about the central point thereof.

9. The wrench device of claim 5 wherein said wrench body is flat and includes opposed planar parallel faces.

10. The wrench device of claim 8 wherein said wrench body is flat and includes opposed planar parallel faces.

11. The wrench device of claim 8 wherein said wrench openings of said first and second arrays comprise varying size box end wrench openings, and
one of said first and second arrays comprises American Standard sizes, the other of said first and second arrays comprising metric standard sizes.

12. The wrench device of claim 11 wherein the wrench openings of said first and second arrays comprise 12-point box end wrench openings.

13. The wrench device according to claim 11 wherein the wrench openings of said first and second arrays are spaced apart a minimum distance of approximately ⅛″.

14. The wrench device of claim 13 wherein said elongated handle has a length of approximately 11″.
